(19) United States
(12) Patent Application Publication
(10) Pub. No.: US 2020/0398828 A1
(43) Pub. Date: Dec. 24, 2020

(54) MEASUREMENT DEVICE, MEASUREMENT METHOD, MEASUREMENT PROGRAM, RECORDING MEDIUM HAVING MEASUREMENT PROGRAM RECORDED THEREIN, AND VEHICLE CONTROL DEVICE

(71) Applicant: Panasonic Intellectual Property Management Co., Ltd., Osaka (JP)

(72) Inventors: Yuichi ISHIKAWA, Kanagawa (JP); Masaki KANEMARU, Tokyo (JP)

(73) Assignee: Panasonic Intellectual Property Management Co., Ltd., Osaka (JP)

(21) Appl. No.: 16/968,485

(22) PCT Filed: Feb. 15, 2019
(86) PCT No.: PCT/JP2019/005651

§ 371 Date: Aug. 7, 2020

(30) Foreign Application Priority Data
Feb. 15, 2018 (JP) 2018-025327

(51) Int. Cl. B60W 30/06; G01S 15/46; G01S 15/931; G01S 15/60

(52) U.S. Cl. CPC B60W 30/06; G01S 15/46; G01S 2015/932; G01S 15/60; G01S 15/931

(57) ABSTRACT

This measurement device is provided with: a relative velocity calculation unit that calculates the relative velocity of an object with respect to a mobile body or the relative velocity of the mobile body with respect to the object on the basis of a sound wave which is transmitted to the object from a transmission unit provided to the mobile body and a reflected wave that results from reflection of the transmitted sound wave on the object and that is received by a reception unit provided to the mobile body; a flight time measurement unit that measures flight time which is the time required for a transmitted ultrasonic wave to reflect on the object and to reach the reception unit; and a position identification unit that identifies the position of the object on the basis of the relative velocity and the flight time.

### TECHNICAL FIELD

This disclosure pertains to measurement apparatuses, measurement methods, measurement programs, recording media recording a measurement program, and vehicle control apparatuses.

### BACKGROUND ART

Conventionally, a measurement apparatus for measuring a distance to an object or the like using sound waves is known (Patent Literature 1, hereinafter referred to as PTL 1).

### CITATION LIST

### Patent Literatures

### PTL 1

### WO 2008/023714

### SUMMARY OF INVENTION

### Technical Problem

In the measurement apparatus described in PTL 1, a distance to an object or the like is measured by multiple ultrasonic waves having different frequencies. Therefore, the measurement process becomes complicated. Further, in the measurement apparatus described in PTL 1, an improvement in accuracy of detecting a position of an object is required.

It is an object of the present disclosure to accurately detect a position of an object using sound waves.

### Solution to Problem

An aspect of the present disclosure is a measurement apparatus comprising: a relative velocity calculator that calculates a relative velocity of an object with respect to a moving body or a relative velocity of the moving body with respect to the object based on sound waves that have been transmitted from a transmitter provided in the moving body toward the object and reflected waves that are reflected by the object and received by a receiver provided in the moving body; a time-of-flight measurer that measures a time of flight which is a time until the transmitted sound waves are reflected by the object and reach the receiver; and a position identifier that identifies a position of the object based on the relative velocity calculated by the relative velocity calculator and the time of flight measured by the time-of-flight measurer.

### Advantageous Effects of Invention

According to the present disclosure, a position of an object can be detected with high accuracy.

### BRIEF DESCRIPTION OF DRAWINGS

FIG. 1 is a block diagram illustrating a configuration of a driving support system including a measurement apparatus;

FIG. 2 is a flowchart illustrating the content of a measurement process performed by a measurement apparatus;

FIG. 3A is a diagram illustrating a method for calculating a relative velocity of an object relative to a moving body;

FIG. 3B is a schematic diagram illustrating a positional relationship between a moving body and an object;

FIG. 4A is a schematic diagram illustrating a state in which a vehicle moving in a parking lot detects a parkable area;

FIG. 4B is a schematic diagram illustrating a state in which a vehicle moving in a parking lot detects a parkable area;

FIG. 4C is a schematic diagram illustrating a state in which a vehicle moving in a parking lot detects a parkable area;

FIG. 4D is a schematic diagram illustrating a state in which a vehicle moving in a parking lot detects a parkable area;

FIG. 4E is a schematic diagram illustrating a state in which a vehicle moving in a parking lot detects a parkable area;

FIG. 5 is a block diagram illustrating a configuration of a vehicle control apparatus for performing parking assistance;

FIG. 6 is a flowchart illustrating a process performed by a vehicle control apparatus performing parking assistance;

FIG. 7 is a block diagram illustrating a configuration of a vehicle control apparatus that performs collision avoidance assistance;

FIG. 8 is a flowchart illustrating the content of a measurement process performed by a measurer;

FIG. 9A is a diagram for explaining a state in which a position of an object is identified;

FIG. 9B is a diagram for explaining a state in which a position of an object is identified;

FIG. 9C is a diagram for explaining a state in which a position of an object is identified;

FIG. 9D is a diagram for explaining a state in which a position of an object is identified;

FIG. 10 is a flowchart illustrating a process performed by a vehicle control apparatus performing collision avoidance assistance.

### DESCRIPTION OF EMBODIMENTS

Hereinafter, embodiments of the present disclosure will be described in detail with reference to the drawings. Note that the embodiments described below are an example, and the present disclosure is not limited thereto.

(Configuration of Driving Support System)

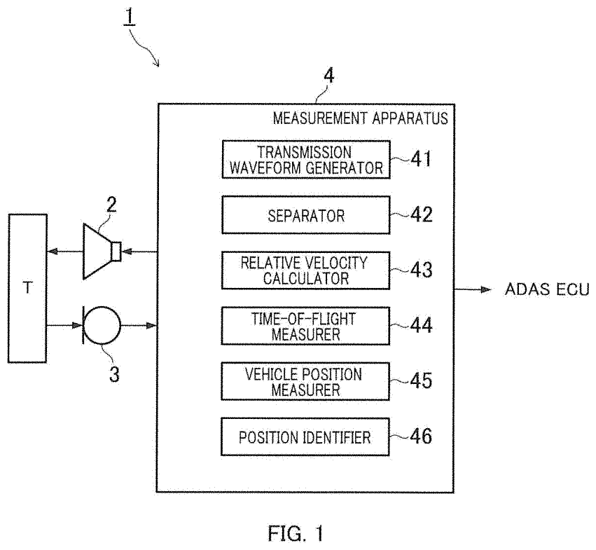

The configuration of driving support system 1 is described with reference to FIG. 1. FIG. 1 is a block diagram illustrating a configuration of driving support system 1.

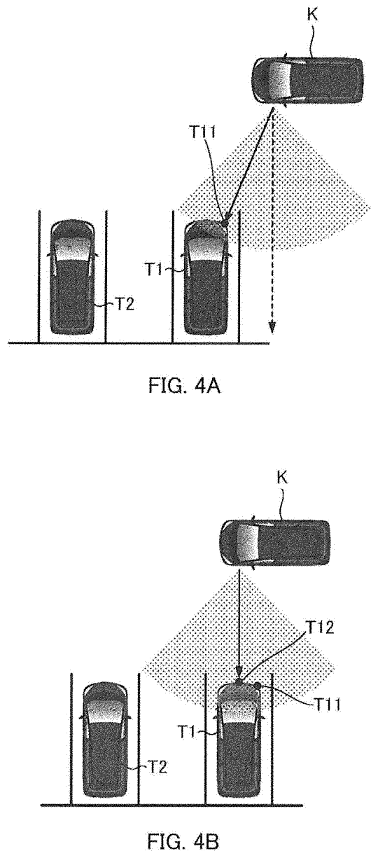

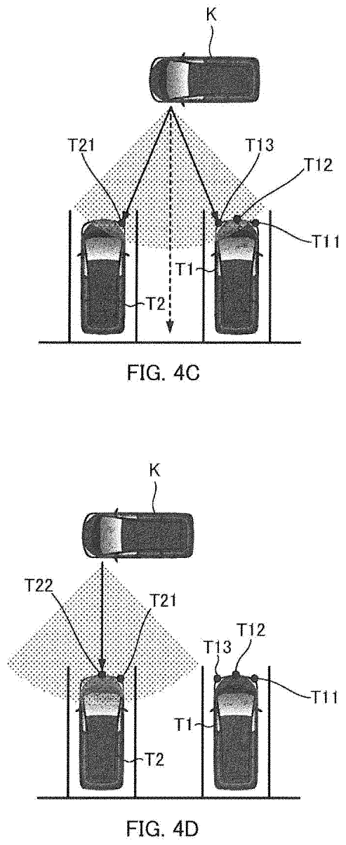

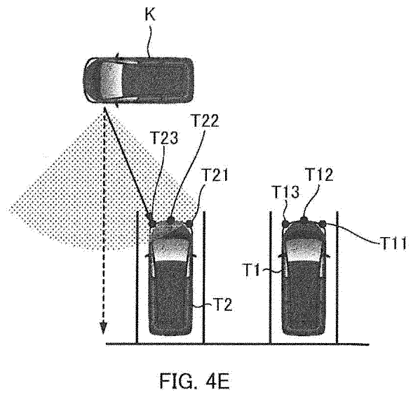

Driving support system 1 is mounted on a moving body K (refer to FIG. 4A), such as a vehicle, and includes transmitter 2, receiver 3, and measurement apparatus 4.

Transmitter 2 is provided, for example, on a lateral side of moving body K, receives an electrical signal (voltage signal) from transmission waveform generator 41 (described later), and transmits ultrasonic waves toward a lateral side of moving body K. The ultrasonic waves transmitted from transmitter 2 are reflected by object T. In the following description, it is assumed that object T is stationary.

Receiver 3 is provided in the vicinity of transmitter 2, for example, and receives ultrasonic waves. The ultrasonic waves received by receiver 3 include reflected waves that are the ultrasonic waves that have been transmitted from transmitter 2 and reflected by object T. For example, receiver 3 may commonly use the same device as that used by transmitter 2, or may be provided at a position different from that of transmitter 2.

Measurement apparatus 4 has transmission waveform generator 41, separator 42, relative velocity calculator 43, time-of-flight measurer 44, vehicle position measurer 45, and position identifier 46.

Measurement apparatus 4 is, for example, an ECU (Electronic Control Unit), and includes an input terminal, an output terminal, a processor, a program memory, and a main memory which are mounted on a control board, to control lateral monitoring of moving body K.

Transmission waveform generator 41 generates a predetermined electrical signal corresponding to the components of the ultrasonic waves to be transmitted from transmitter 2, and outputs to transmitter 2. In transmitter 2, the piezoelectric element and the resonant plate that are not shown is resonated in response to the electrical signal received from transmission waveform generator 41, and the ultrasonic waves generated by the resonance is transmitted toward a lateral side of moving body K.

Separator 42, from the ultrasonic waves received by receiver 3, extracts the reflected waves described above, and separates the reflected waves by frequency (specifically, for each predetermined frequency region configured in advance), for example, by using a band-pass filter.

Relative velocity calculator 43 calculates a relative velocity of object T with respect to moving body K based on the electrical signal generated by transmission waveform generator 41 and the electrical signals separated with the separator 42 by frequency. A specific method for calculating a relative velocity of object T with respect to moving body K will be described later.

Time-of-flight measurer 44 measures a time from a transmission by transmitter 2 of ultrasonic waves to a reception by receiver 3 of the ultrasonic waves after having been reflected by object T (hereinafter referred to as “time of flight”).

Vehicle position measurer 45 measures a position of moving body K using, for example, the rotational velocity and the rotational direction of the wheels of moving body K, and GNSS (Global Navigation Satellite System) information, and the like.

Position identifier 46 identifies a position of object T based on the relative velocity of object T with respect to moving body K calculated by relative velocity calculator 43, the time of flight of the ultrasonic waves measured by time-of-flight measurer 44, and the position of moving body K measured by vehicle position measurer 45.

In the present embodiment, measurement apparatus 4 is connected to an ADAS (Advanced Driver Assistance System) ECU, and the position of object T identified by position identifier 46 is output to the ADAS ECU. The ADAS ECU uses these data to automatically control moving body K.

(Measurement Process)

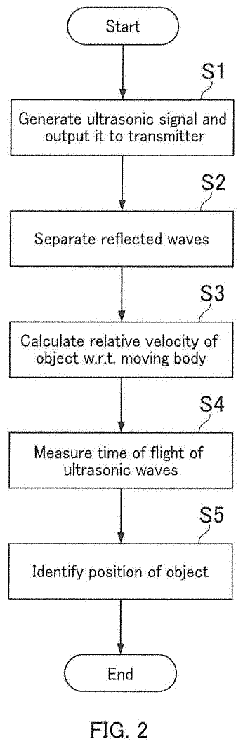

Referring to FIG. 2, a description is given of a measurement process performed by measurement apparatus 4. FIG. 2 is a flowchart showing the content of the measurement process performed by measurement apparatus 4. Such a measurement process is repeatedly performed at a predetermined period.

In Step S1, measurement apparatus 4 generates a predetermined electrical signal corresponding to the components of ultrasonic waves to be transmitted from transmitter 2, and outputs it to transmitter 2. As a result, predetermined ultrasonic waves are transmitted from transmitter 2 toward object T. The ultrasonic waves transmitted from transmitter 2 toward object T are reflected by object T and then received by receiver 3.

In the subsequent Step S2, measurement apparatus 4 extracts the reflected waves from the ultrasonic waves received by receiver 3, and separates the reflected waves by frequency.

In the subsequent Step S3, measurement apparatus 4 calculates a relative velocity of object T with respect to moving body K from the frequency of the ultrasonic waves transmitted from transmitter 2, the frequency of the reflected waves received by receiver 3, and the velocity of moving body K.

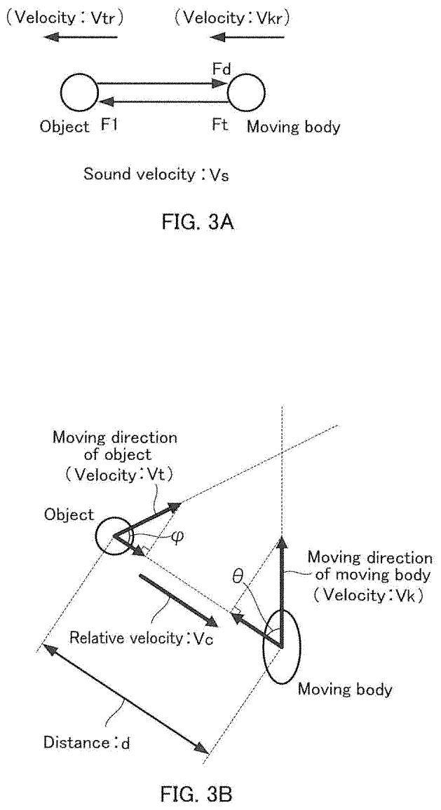

Now, referring to FIG. 3A, an exemplary method for calculating a relative velocity of object T relative to moving body K is described in detail. As shown in FIG. 3A, consider the case where moving body K is moving in the direction toward object T at velocity Vkr and object T is moving at the velocity Vtr in the same direction as the moving direction of moving body K.

At this time, denoting the frequency of the ultrasonic waves that have been transmitted from transmitter 2 of moving body K by Ft, the frequency of the ultrasonic waves when the ultrasonic waves transmitted from transmitter 2 reach object T by F1, the frequency of the reflected waves received by receiver 3 by Fd, and the sound velocity by Vs, regarding the ultrasonic waves that have been transmitted from transmitter 2 toward object T, it follows:

F1=Ft·(Vs−Vtr)/(Vs−Vkr) (1), and

with respect to the reflected waves reflected by object T and received by receiver 3, it follows:

$$\begin{matrix}Fd = F 1 \cdot ( Vs - ( - ( Vkr ) ) / ( Vs - ( - Vtr ) ) \\ = F 1 \cdot ( Vs + Vkr ) / ( Vs + Vtr ) .\end{matrix} \qquad ( 2 )$$

Equations (1) and (2) can be approximated as follows:

F1=Ft·(Vs−(Vtr−Vkr))/Vs (3), and

Fd=F1·Vs/(Vs+(Vtr−Vkr)) (4).

When equations (3) and (4) are combined, it follows:

Fd=Ft·(Vs−(Vtr−Vkr))/(Vs+(Vtr−Vkr)) (5).

Since relative velocity Vc of object T with respect to moving body K is Vc=Vtr−Vkr, Equation (5) can be expressed as:

Fd=Ft·(Vs−Vc)/(Vs+Vc) (6).

Therefore, relative velocity Vc of object T with respect to moving body K is as follows:

Vc=Vs·(Ft−Fd)/(Ft+Fd) (7).

Measurement apparatus 4, using Equation (7), calculates relative velocity Vc of object T with respect to moving body K.

In Step S4 following Step S3, measurement apparatus 4 measures time of flight tTOF of the ultrasonic waves that have been transmitted from transmitter 2, reflected by object T, and received by receiver 3.

In the subsequent Step S5, measurement apparatus 4 identifies a position of object T from relative velocity Vc calculated in Step S3 and time of flight tTOF measured in Step S4.

Here, referring to FIG. 3B, an example of a method for identifying the position of object T (specifically, relative position (d, θ) of object T with respect to moving body K) is described in detail. Here, d is the distance between moving body K and object T, and θ is an angle formed by the direction from moving body K toward object T with respect to the moving direction of moving body K. FIG. 3B is a schematic diagram illustrating a positional relationship between moving body K and object T.

As shown in FIG. 3B, when moving body K is moving at velocity Vk and object T is moving at velocity Vt, and the angle formed by the direction from moving body K toward object T with respect to the moving direction of moving body K is θ, and the angle formed by the direction from object T toward moving body K with respect to the moving direction of object T is φ, relative velocity Vc of object T with respect to moving body K is expressed by Equation (8):

Vc=Vt·cos φ−Vk·cos θ (8).

In particular, if object T is stationary (Vt=0), then Equation (8) can be expressed as

Vc=−Vk·cos θ (9).

Therefore, angle θ formed by the direction from moving body K toward object T with respect to the moving direction of moving body K can be obtained from

θ=cos⁻¹(−Vc/Vk) (10).

In addition, distance d between moving body K and object T can be obtained from

d=Vs·t_{TOF}/2 (11).

In the above-described embodiment, an example is described in which angle θ formed by the direction from moving body K toward object T with respect to the moving direction of moving body K is calculated using relative velocity Vc of object T with respect to moving body K, however angle θ may be calculated using relative velocity (−Vc) of moving body K with respect to object T.

(Application to Detection of Parkable Area)

Referring to FIGS. 4A to 4E, it is described how a vehicle moving in the parking lot detects a parkable area. FIGS. 4A to 4E are schematic diagrams illustrating a state in which a vehicle moving in a parking lot detects a parkable area.

As shown in FIG. 4A, transmitter 2 is disposed toward a direction orthogonal to the moving direction of moving body K, and ultrasonic waves are transmitted toward a lateral side of moving body K. In FIGS. 4A to 4E, an area toward which the ultrasonic waves are transmitted is shown hatched. For example, the horizontal FOV (Field of View) of the ultrasonic waves transmitted from transmitter 2 is 60°. Such an FOV can be arbitrarily configured. In the state of FIG. 4A, there is no vehicle parked at a lateral side of moving body K, and vehicle T1 is parked diagonally forward to the left with respect to the moving direction of moving body K. Right front surface T11 of vehicle T1 is assumed to be a surface substantially orthogonal to the travelling direction of the ultrasonic waves that have been transmitted from transmitter 2.

At this time, reflected waves reflected by right front surface T11 of vehicle T1 are strongly received by receiver 3. On the other hand, reflected waves reflected by a surface other than right front surface T11 of vehicle T1 (e.g., a side surface of vehicle T1) are hardly received. Therefore, measurement apparatus 4, using the reflected waves reflected by right front surface T11 of vehicle T1, identifies a position of right front surface T11 of vehicle T1.

Moving body K continues moving forward, and in a state in which front surface T12 of vehicle T1 is present at a lateral side of moving body K as shown in FIG. 4B, reflected ultrasonic waves reflected by front surface T12 of vehicle T1 are strongly received by receiver 3. Such reflected waves have the same wavelength as the transmitted ultrasonic waves. Measurement apparatus 4 identifies a position of front surface T12 of vehicle T1 based on the reflected waves.

After moving body K further continues moving forward, vehicle T1 is positioned diagonally rearward to the left of moving body K, and vehicle T2 parked at a distance from vehicle T1 is positioned diagonally forward to the left of moving body K, as shown in FIG. 4C. Again, right front surface T21 of vehicle T1 and left front surface T13 of vehicle T2 are assumed to be a plane substantially orthogonal to the travelling direction of the ultrasonic waves that have been transmitted from transmitter 2.

In this case, the reflected waves of the ultrasonic waves reflected by left front surface T13 of vehicle T1 and the reflected waves reflected by right front surface T21 of vehicle T2 is strongly received by receiver 3. Measurement apparatus 4 identifies a position of left front surface T13 of vehicle T1 based on the reflected waves reflected by left front surface T13 of vehicle T1 and identifies a position of right front surface T21 of vehicle T2 based on the reflected waves reflected by right front surface T21 of vehicle T2.

Similarly, the position of front surface T22 of vehicle T2 is identified in a state illustrated in FIG. 4D, and the position of left front surface T23 of vehicle T2 is identified in a state illustrated in FIG. 4E. In this way, it is possible to specify the contour of the front side of vehicles T1 and T2 parked at a lateral side of moving body K.

When a contour of the front surface of vehicles T1 and T2 which are parked at a lateral side of moving body K is identified, in ADAS ECU, a space is determined in which a parked vehicle does not exist, it is determined whether or not moving body K can be parked based on the size of the space and the size and the position of moving body K, and automatic parking is performed when it is determined that moving body K can be parked.

As described above, the measurement apparatus according to the present disclosure includes: a relative velocity calculator that calculates a relative velocity of an object with respect to a moving body or a relative velocity of the moving body with respect to the object based on the sound waves transmitted from a transmitter provided in the moving body toward the object and the reflected waves that are transmitted sound waves reflected by the object and received by a receiver provided in the moving body; a time-of-flight measurer that measures a time of flight which is a time until the transmitted sound waves are reflected by the object and reach the receiver; a position identifier that identifies a position of the object based on the relative velocity calculated by the relative velocity calculator and the time of flight measured by the time-of-flight measurer.

According to the measurement apparatus of the present disclosure, it is possible to accurately detect a position of an object.

In the above-described embodiments, examples have been described in which a transmitter is disposed toward a direction orthogonal to the moving direction of a moving body, however the present disclosure is not limited thereto. By using the measurement apparatus according to the present disclosure, a position of an object can be identified even when a transmitter is disposed toward a direction other than a direction orthogonal to the moving direction of a moving body. For example, even when a transmitter cannot be mounted so as to face a direction orthogonal to the moving direction of a moving body due to the bumper shape, it is possible to identify a position of an object.

In the above-described embodiments, examples have been described of identifying a position of an object which exists in each of the directions forming various angles with respect to the moving direction of a moving body including an exactly lateral direction of a moving body, however the present disclosure is not limited thereto. For example, by extracting only reflected waves having an arbitrarily fixed frequency, only an object which exists in a specific direction from a moving body may be detected. As a result, the processing load can be reduced.

In the above-described embodiments, examples have been described in which sound waves are used, however the present disclosure is not limited thereto. A radar can also be used to identify a position of an object in the same way as in the above-described embodiments.

In the above-described embodiments, examples have been described in which a relative velocity of an object with respect to a moving body is calculated by using the frequency of the sound waves, however the present disclosure is not limited thereto. A relative velocity of an object with respect to a moving body can also be calculated by using the wavelength of sound waves in the same way as in the above-described embodiments.

In the above-described embodiments, examples have been described in which a relative velocity of an object with respect to a moving body is calculated using Equation (7), and the angle formed between the moving direction of the moving body and the direction from the moving body toward the object is calculated using Equation (10), however the present disclosure is not limited thereto.

For example, using the following Equation (12) obtained by composing Equations (7) and (10), an angle θ formed by the direction from the moving body toward an object with respect to the moving direction of a moving body can be calculated from the frequency of the ultrasonic waves that have been transmitted from a transmitter, the frequency of reflected waves received by a receiver, the velocity of the object, and the velocity of the moving body.

θ=cos⁻¹(((Fd−Ft)·Vs)/((Fd+Ft)·Vk)) (12)

In the above-described embodiments, examples have been described by way of an application to automatic parking, however the present disclosure is not limited thereto. For example, it is conceivable to apply the disclosure to obstacle detection such as at a right or left turn. In this case, in response to detecting an obstacle being present in the left or right front of the moving body, an alarm may be issued to the driver.

(Vehicle Control Apparatus 100)

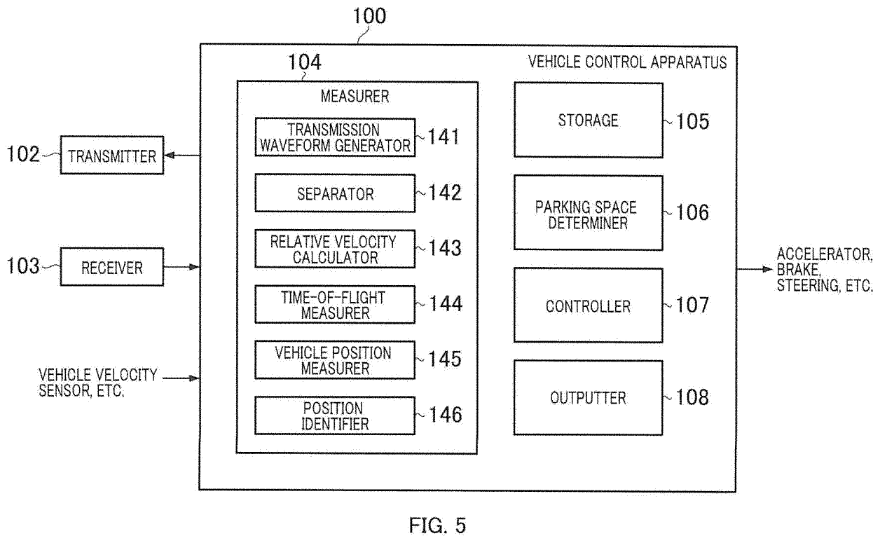

Next, vehicle control apparatus 100 is described which is configured to include measurer 104 having the same functionality as measurement apparatus 4 described above and performs parking assistance of vehicle K. FIG. 5 is a block diagram illustrating a configuration of vehicle control apparatus 100.

As shown in FIG. 5, vehicle control apparatus 100 is mounted on vehicle K and is electrically connected to transmitter 102, receiver 103, various sensors such as a vehicle velocity sensor, and various actuators related to the operation of the accelerator, the brake, the steering, or the like.

Since transmitter 102 and receiver 103 have the same configuration as that of transmitter 2 and receiver 3, respectively, which have been already described above, detailed description thereof is omitted. Transmitter 102 and receiver 103 are provided on a lateral side of vehicle K.

Vehicle control apparatus 100 has measurer 104, storage 105, parking space determiner 106, controller 107, and outputter 108.

Measurer 104 identifies a position of object T based on the frequency of the ultrasonic waves transmitted from transmitter 102 and the frequency of the ultrasonic waves received by receiver 103 or the like. Measurer 104 has transmission waveform generator 141, separator 142, relative velocity calculator 143, time-of-flight measurer 144, vehicle position measurer 145, and position identifier 146.

Since transmission waveform generator 141, separator 142, relative velocity calculator 143, time-of-flight measurer 144, vehicle position measurer 145, and position identifier 146 have the same configuration as that of transmission waveform generator 41, separator 42, relative velocity calculator 43, time-of-flight measurer 44, vehicle position measurer 45, and position identifier 46, respectively, which have been already described above, detailed description thereof is omitted.

Storage 105 stores the parameters of vehicle K, for example, the width, the length, and the like, of vehicle K.

Parking space determiner 106 determines the parking space for parking vehicle K based on the parameters of vehicle K stored in storage 105 and the position of object T identified by measurer 104.

Controller 107 generates a control signal to be output to each of the parts of vehicle K (various actuators related to the operation of the accelerator, the brake, the steering, or the like) in order to park vehicle K in the parking space determined by parking space determiner 106.

Outputter 108 outputs the control signal generated by controller 107 to each of the parts of vehicle K (various actuators related to the operation of the accelerator, the brake, the steering, or the like). As a result, automatic parking of vehicle K is performed.

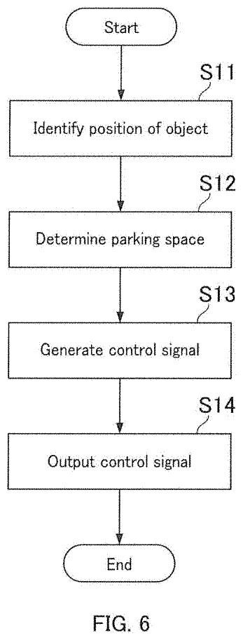

Referring to FIG. 6, a description is given of the process performed by vehicle control apparatus 100. FIG. 6 is a flowchart showing a process performed by vehicle control apparatus 100. The process shown in FIG. 6 is repeatedly performed at a predetermined period.

In Step S11, vehicle control apparatus 100 (specifically, measurer 104) identifies a position of object T.

In the subsequent Step S12, vehicle control apparatus 100 (specifically, parking space determiner 106) reads the parameters of vehicle K stored in storage 105 and determines a parking space for parking vehicle K based on the parameters of vehicle K read and the position of object T identified by measurer 104.

In the subsequent Step S13, vehicle control apparatus 100 (specifically, controller 107) generates a control signal to be output to each of the parts of vehicle K (various actuators related to the operation of the accelerator, the brake, the steering, or the like) in order to park vehicle K in the parking space determined in Step S12.

In subsequent Step S14, vehicle control apparatus 100 (specifically, outputter 108) outputs the control signal generated in Step S13 to each of the parts of vehicle K to be controlled (various actuators related to the operation of the accelerator, the brake, the steering, or the like).

As described above, vehicle control apparatus 100 includes: relative velocity calculator 143 for calculating a relative velocity of vehicle K with respect to object T or a relative velocity of object T with respect to vehicle K based on the sound waves that have been transmitted from transmitter 102 provided in vehicle K toward object T and reflected waves that are the transmitted sound waves reflected by object T and received by receiver 103 provided in vehicle K; time-of-flight measurer 144 for measuring a time of flight which is a time until the transmitted sound waves are reflected by object T and reach receiver 103; position identifier 146 for identifying a position of object T based on the relative velocity calculated by relative velocity calculator 143 and the time of flight measured by time-of-flight measurer 144; parking space determiner 106 for determining a parking space for parking vehicle K based on the position of object T identified by position identifier 146 and the size of vehicle K; and controller 107 for parking vehicle K in the parking space determined by parking space determiner 106.

By means of vehicle control apparatus 100, it is possible to accurately detect the position of object T, thereby appropriately determine a parking space for parking vehicle K, thus it is possible to appropriately park vehicle K in a parking space.

(Vehicle Control Apparatus 200)

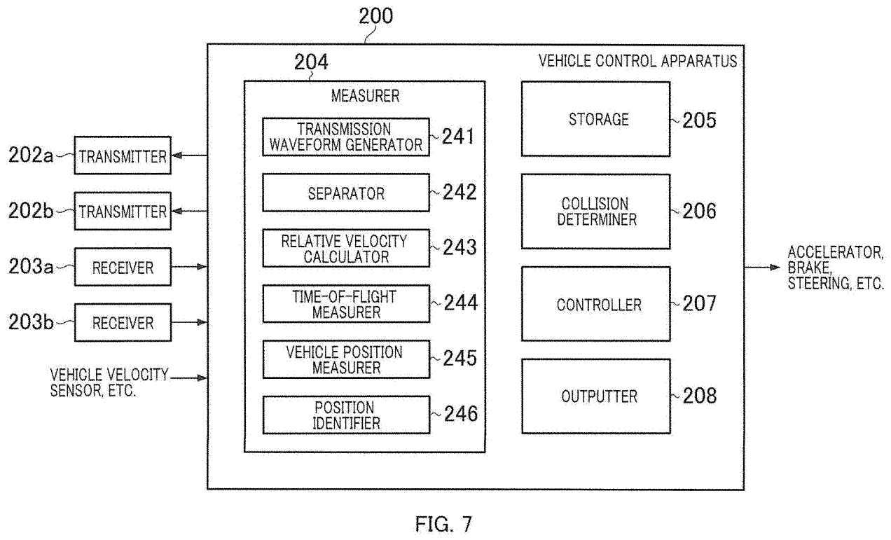

Next, vehicle control apparatus 200 will be described which is configured to include measurer 204 having the same functionality as that of the above-described measurement apparatus 4 and performs collision avoidance assistance of vehicle K. FIG. 7 is a block diagram showing a configuration of vehicle control apparatus 200.

As shown in FIG. 7, vehicle control apparatus 200 is mounted on vehicle K and electrically connected to a plurality of transmitters 202a, 202b, . . . , a plurality of receivers 203a, 203b, . . . , various sensors such as a vehicle velocity sensor, and various actuators related to the operation of the accelerator, the brake, the steering, and the like.

Hereinafter, an example will be described in which vehicle K is moving straight, transmitters 202a, 202b are arranged at the front end of vehicle K in the moving direction thereof and at intervals in the vehicle width direction, and ultrasonic waves are transmitted from transmitters 202a, 202b toward the moving direction of vehicle K. However, the number of transmitters and the direction of the ultrasonic waves transmitted from the transmitter are not limited thereto.

Since transmitters 202a, 202b and receivers 203a, 203b have the same configuration as that of transmitter 2 and receiver 3, respectively, which have been already described above, detailed description thereof is omitted. As described above, transmitters 202a, 202b and receivers 203a, 203b are arranged at the front end of vehicle K in the moving direction thereof and at intervals in the vehicle width direction.

Vehicle control apparatus 200 has measurer 204, storage 205, collision determiner 206, controller 207, and outputter 208.

Measurer 204 identifies a position of object T. Measurer 204 includes transmission waveform generator 241, separator 242, relative velocity calculator 243, time-of-flight measurer 244, vehicle position measurer 245, and position identifier 246.

Since transmission waveform generator 241, separator 242, relative velocity calculator 243, time-of-flight measurer 244, vehicle position measurer 245 and position identifier 246, have the same configuration as that of transmission waveform generator 41, separator 42, relative velocity calculator 43, time-of-flight measurer 44, vehicle position measurer 45, and position identifier 46, respectively, which have been already described above, detailed description thereof is omitted.

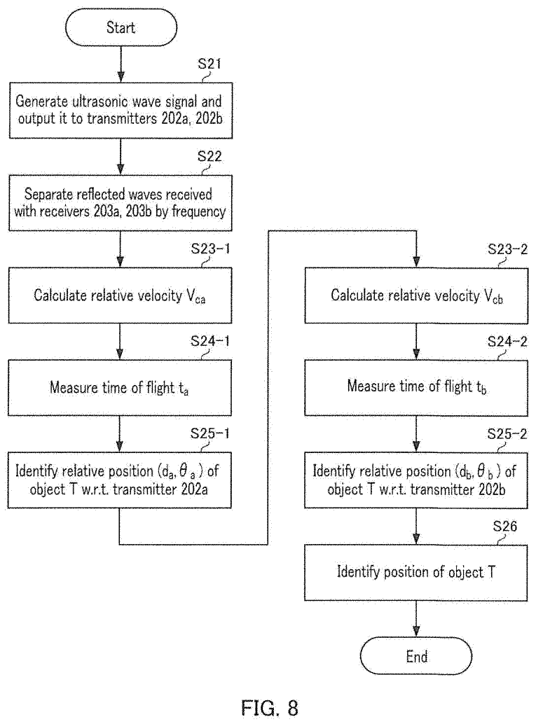

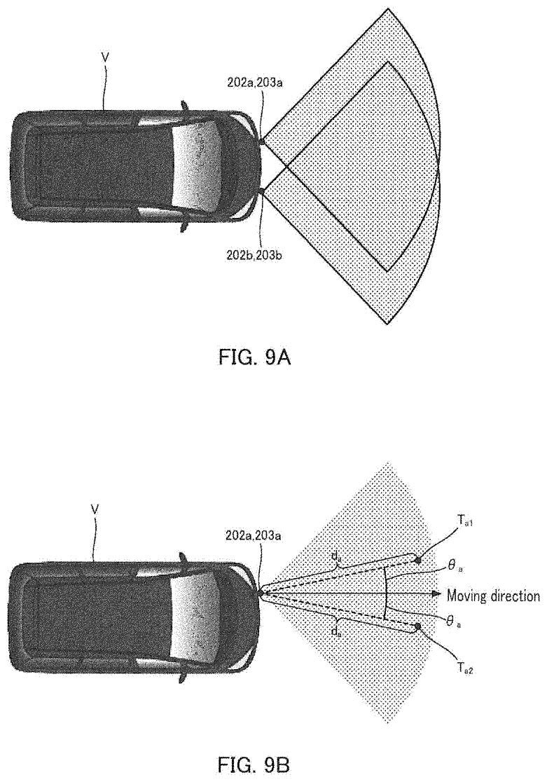

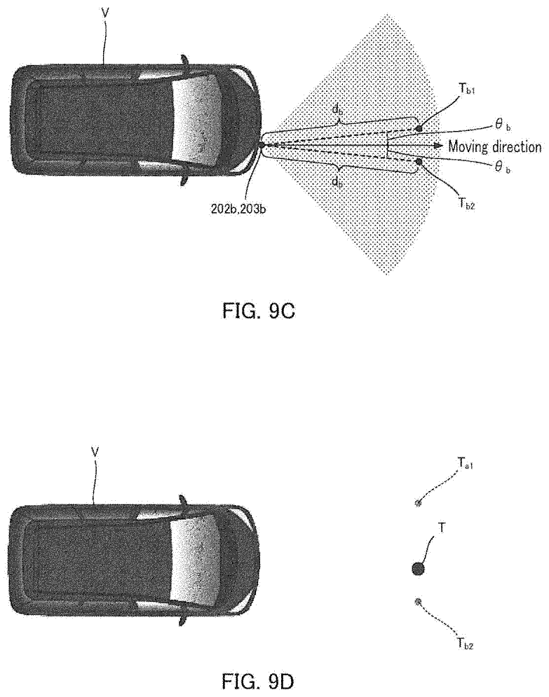

Here, referring to FIG. 8, FIG. 9A, FIG. 9B, FIG. 9C, and FIG. 9D, the measurement process performed by measurer 204 is described. FIG. 8 is a flowchart showing the content of measurement process performed by measurer 204. Such a measurement process is repeatedly performed at a predetermined period. FIGS. 9A to 9D are drawings illustrating how the position of object T is determined.

In Step S21, measurer 204 generates a predetermined electric signal (ultrasonic signal) corresponding to the components of the ultrasonic waves to be transmitted from transmitters 202a, 202b, and outputs the electric signal (ultrasonic signal) to transmitters 202a, 202b. As a result, predetermined ultrasonic waves are transmitted from respective transmitters 202a, 202b (refer to FIG. 9A).

The ultrasonic waves that have been transmitted from transmitter 202a are reflected by object T and received by receiver 203a. The ultrasonic waves that have been transmitted from transmitter 202b are reflected by object T and received by receiver 203b. The components of the ultrasonic waves transmitted from transmitter 202a and the components of the ultrasonic waves transmitted from transmitter 202b may be the same or different from each other.

In Step S22, measurer 204 extracts reflected waves from the ultrasonic waves received by receivers 203a, 203b, and separates the reflected waves by frequency.

In the subsequent Step S23-1, measurer 204 calculates relative velocity V_{ca} of object T with respect to transmitter 202a from the frequency of the ultrasonic waves that have been transmitted from transmitter 202a, the frequency of the reflected waves received by receiver 203a, and sound velocity Vs.

In the subsequent Step S24-1, measurer 204 measures time of flight tₐ of the ultrasonic waves that have been transmitted from transmitter 202a, reflected by object T, and received by receiver 203a.

In the subsequent Step S25-1, measurer 204 identifies a position of object T (specifically, relative position (dₐ, θₐ) of object T with respect to transmitter 202a) from relative velocity V_{ca} calculated in Step S23-1 and time of flight tₐ measured in Step S24-1. Here, dₐ is the distance between transmitter 202a and object T, and θₐ is an angle formed by the direction from transmitter 202a toward object T with respect to the moving direction of transmitter 202a (that is, the moving direction of vehicle K).

When θₐ is 0, the position of object T is identified to be the front of transmitter 202a. Otherwise, when θₐ is not 0, as shown in FIG. 9B, the position of object T is identified to be either position Tₐ₁ on the left side of transmitter 202a or position Tₐ₂ on the right side of transmitter 202a.

In the following S23-2, measurer 204 calculates relative velocity V_{cb} of object T with respect to transmitter 202b from the frequency of the ultrasonic waves that have been transmitted from transmitter 202b, the frequency of the reflected waves received by receiver 203b, and the velocity of vehicle K.

In the subsequent Step S24-2, measurer 204 measures time of flight t_{b} of the ultrasonic waves that have been transmitted from transmitter 202b, reflected by object T, and received by receiver 203b.

In the subsequent Step S25-2, measurer 204 identifies a position of object T (specifically, relative position (d_{b}, θ_{b}) of object T with respect to transmitter 202b) from relative velocity V_{cb} calculated in Step S23-2 and time of flight t_{b} measured in Step S24-2. Here, d_{b} is the distance between transmitter 202b and object T, θ_{b} is an angle formed by the direction from transmitter 202b toward object T with respect to the moving direction of transmitter 202b (i.e., the moving direction of vehicle K).

When θ_{b} is 0, the position of object T is identified to be the front of transmitter 202b. Otherwise, when θ_{b} is not 0, as shown in FIG. 9C, the position of object T is identified to be either position T_{b1} on the right side of transmitter 202b or position T_{b2} on the left side of the moving direction of vehicle K.

In the subsequent Step S26, measurer 204 identifies a position of object T from relative position (dₐ, θₐ) of object T with respect to transmitter 202a identified in Step S25-1 and relative position (d_{b}, θ_{b}) of object T with respect to transmitter 202b identified in Step S25-2.

In the above explanation, the processes from Step S23-2 to Step S25-2 are performed after the processes from Step S23-1 to Step S25-1, however the sequence of the processes is not limited thereto. The processes from Step S23-2 to Step S25-2 may be performed first. The processes from Step S23-1 to Step S25-1 and the processes from Step S23-2 to Step S25-2 may be performed simultaneously.

When three or more transmitters and receivers are provided, for each transmitter, a relative velocity may be calculated, a time of flight may be measured, and relative positions of an object with respect to the transmitters may be identified, and relative positions of the object with respect to any two or more transmitters can be used to identify a position of the object.

Returning to the description of FIG. 7, storage 205 stores the parameters of vehicle K, for example, the width, the height, and the like, of vehicle K.

Collision determiner 206 determines whether or not vehicle K will collide with object T based on the parameters of vehicle K stored in storage 205 and the position of object T identified by measurer 204.

When it is determined by collision determiner 206 that vehicle K will collide with object T, controller 207 outputs to each of the parts of vehicle K (various actuators related to the operation of the accelerator, the brake, the steering, or the like) in order to avoid collision with object T. Thus, a collision avoidance operation of vehicle K is performed.

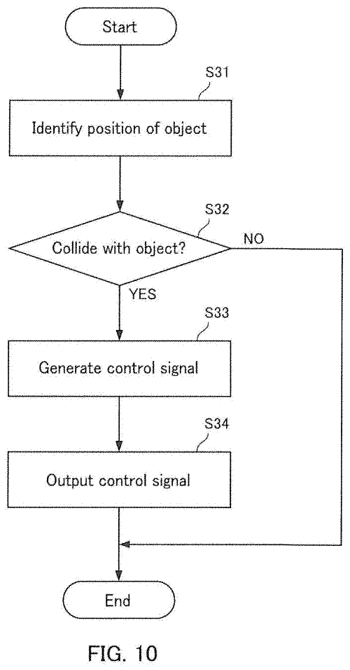

With reference to FIG. 10, the process performed by vehicle control apparatus 200 will be described. FIG. 10 is a flowchart showing a process performed by vehicle control apparatus 200. The process shown in FIG. 10 is repeatedly performed at a predetermined period. As described above, it is assumed that vehicle K is moving straight.

In Step S31, vehicle control apparatus 200 (specifically, measurer 204) identifies a position of object T.

In subsequent Step S32, vehicle control apparatus 200 (specifically, collision determiner 206) reads the parameters of vehicle K stored in storage 205, and determines whether vehicle K will collide with object T when vehicle K continues moving straight based on the parameters of vehicle K read and the position of object T identified by measurer 204.

If it is determined in Step S32 that vehicle K does not collide with object T (Step S32:NO), the process ends.

On the other hand, if it is determined in Step S32 that vehicle K will collide with object T (Step S32:YES), the process proceeds to Step S33.

In Step S33, vehicle control apparatus 200 (specifically, controller 207) generates a control signal to be output to each of the parts of vehicle K (various actuators related to the operation of the accelerator, the brake, the steering, or the like) in order to avoid collision with object T.

In the subsequent Step S34, vehicle control apparatus 200 (specifically, outputter 208) outputs the control signal generated in Step S33 to each of the parts of vehicle K to be controlled (actuators related to the operation of the accelerator, the brake, the steering, or the like).

As a control signal for avoiding collision with object T, for example, a signal for increasing the braking force to stop vehicle K is exemplified. Also, as a control signal for avoiding a collision with object T, for example, a signal for operating the steering to change the moving direction of vehicle K is exemplified. A control signal for avoiding collision with object T is not limited to the example described above.

As described above, vehicle control apparatus 200 includes: relative velocity calculator 243 configured to calculate a relative velocity of object T with respect to vehicle K or the relative velocity of vehicle K with respect to object T, based on the sound waves that have been transmitted from transmitters 202a, 202b provided in vehicle K toward object T and reflected waves that are transmitted sound waves reflected by object T and received by receivers 203a, 203b provided in vehicle K; time-of-flight measurer 244 configured to measure a time of flight which is a time until the transmitted sound waves are reflected by object T and reach receivers 203a, 203b; position identifier 246 configured to identify a position of object T based on the relative velocity calculated by relative velocity calculator 243 and the time of flight measured by time-of-flight measurer 244; a collision determiner 206 configured to determine whether vehicle K will collide with object T based on the position of object T identified by position identifier 246 and the size of vehicle K; and controller 207 configured to control the movement of vehicle K so as to avoid collision with object T if it is determined that vehicle K will collide with object T by collision determiner 206.

According to vehicle control apparatus 200, it is possible to accurately detect the position of object T, thereby appropriately determining whether or not vehicle K will collide with object T, and if it is determined that vehicle K will collide with object T, it is possible to appropriately control the movement of vehicle K so as to avoid the collision with object T.

In vehicle control apparatus 200, relative velocity calculator 243 calculates relative velocity V_{ca} of object T with respect to transmitter 202a and relative velocity V_{cb} of object T with respect to transmitter 202b, and time-of-flight measurer 244 measures time of flight tₐ of the sound waves that have been transmitted from transmitter 202a and reflected by object T to reach receiver 203a, and time of flight t_{b} of the sound waves that have been transmitted from transmitter 202b and reflected by object T to reach receiver 203b, and position identifier 246 identifies a position of object T based on the position of object T identified by relative velocity V_{ca} and time of flight tₐ, and the position of object T identified by relative velocity V_{ca} and time of flight tₐ.

According to vehicle control apparatus 200 having the above-described configuration, the position of object T can be accurately detected by using a plurality of sensors having a transmitter and a receiver.

In the above-described embodiments, examples have been described in which receiver 203a receives the ultrasonic waves that have been transmitted from transmitter 202a and reflected by object T, and receiver 203b receives the ultrasonic waves that have been transmitted from transmitter 202b and reflected by object T, however the correspondence between a transmitter and a receiver is not limited thereto.

For example, the ultrasonic waves that have been transmitted from transmitter 202a and reflected by object T may be received by receiver 203b, and the ultrasonic waves that have been transmitted from transmitter 202b and reflected by object T may be received by receiver 203a.

Further, for example, both of the ultrasonic waves that have been transmitted from transmitter 202a and reflected by object T and the ultrasonic waves that have been transmitted from transmitter 202b and reflected by object T may be received by respective receivers 203a, 203b. This improves the robustness.

Further, for example, it is also possible to receive ultrasonic waves that have been transmitted from transmitter 202a or transmitter 202b and reflected by object T by receiver 203a and receiver 203b, and to estimate a position of object T based on the difference in the time of flight of respective ultrasonic waves.

Further, in the above-described embodiment, an example has been described in which the position of the object is identified by using two sensors arranged at interval in the vehicle width direction, and then it is determined whether or not the vehicle will collide with the object, however the present disclosure is not limited thereto. For example, one sensor is arranged at the center in the vehicle width direction, it can be simply determined whether the vehicle will collide with the object based on whether or not the object is present within the range of the vehicle width of the vehicle.

In the embodiment described above, an example has been described in which two sensors are used, however the present disclosure is not limited thereto. For example, a configuration having a plurality of sensors may be simulated with moving a single sensor.

Further, in the above-described embodiment, an example has been described in which the sensors are arranged at intervals in the vehicle width direction to determine the collision possibility between the vehicle and an object in the vehicle width direction, however the present disclosure is not limited thereto. For example, sensors may be arranged at intervals in the height direction to determine whether a vehicle will collide with an object in the air, such as a road sign or a garage ceiling.

In the above-described embodiments, examples of a state has been described in which a vehicle is moving straight, however the present disclosure is not limited thereto. For example, the possibility of collision with an object existing in front in a curve may be determined in consideration of the operation status of the steering of the vehicle or the like.

Further, in the above-described embodiment, an example has been described in which the position of an object is identified based on a relative velocity and a time of flight, and then it is determined whether or not a vehicle will collide with the object, however the present disclosure is not limited thereto. For example, by comparing a relative velocity and a time of flight (i.e., an angle and a distance) with a predetermined threshold based on the vehicle width or the like, it may be simply determined whether the vehicle will collide with the object.

The disclosures of the specification, drawings, and abstract contained in the Japanese Patent Application No. 2018-025327, filed Feb. 15, 2018, are hereby incorporated by reference in their entirety.

### INDUSTRIAL APPLICABILITY

The measurement apparatus according to the present disclosure can accurately detect the position of an object, and is suitably used for detecting a parkable space, determining a collision possibility, or the like.

### REFERENCE SIGNS LIST

1 Driving support system
2, 102, 202a, 202b transmitter
3, 103, 203a, 203b receiver
4 Measurement apparatus
41, 141, 241 Transmission waveform generator
42, 142, 242 Separator
43, 143, 243 Relative velocity calculator
44, 144, 244 Time-of-flight measurer
45, 145, 245 Vehicle position measurer
46, 146, 246 Position identifier
100, 200 Vehicle control apparatus
104, 204 Measurer

1.-12. (canceled)

13. A measurement apparatus comprising:
a relative velocity calculator configured to output a plurality of different relative velocities of a plurality of objects with respect to a moving body or a plurality of different relative velocities of the moving body with respect to the plurality of objects using multiple reflected wave signals formed by one of multiple sound wave signals being reflected by the plurality of objects and received respectively by one or more receivers provided in the moving body, the multiple sound wave signals having been transmitted respectively from one or more transmitters provided in the moving body toward the plurality of objects;
a time-of-flight measurer configured to measure a plurality of times of flight, each time of flight being a time until the one of the multiple sound wave signals is transmitted from the one or more transmitters, reflected by the plurality of objects and reach respective the one or more receivers; and
a position identifier configured to identify respective positions of the plurality of objects based on the plurality of different relative velocities calculated by the relative velocity calculator and the plurality of times of flight measured by the time-of-flight measurer.

14. The measurement apparatus according to claim 13, wherein the relative velocity calculator configured to calculate the plurality of different relative velocities between the moving body and the plurality of objects using a frequency of the one of the multiple sound wave signals, frequencies of the multiple reflected wave signals, and a moving velocity of the moving body.

15. The measurement apparatus according to claim 13, wherein the position identifier is configured to calculate angles, each of the angles being formed by a moving direction of the moving body and a direction from the moving body toward a corresponding one of the plurality of objects, using the plurality of different relative velocities and a moving velocity of the moving body, and calculate a plurality of distances from the moving body to the plurality of objects using the plurality of times of flight.

16. The measurement apparatus according to claim 13, wherein:
the one or more transmitters include a first transmitter and a second transmitter, positions of the first transmitter and the second transmitter being different from each other,
the one or more receivers include a first receiver corresponding to the first transmitter and a second receiver corresponding to the second transmitter, positions of the first receiver and the second receiver being different from each other,
the first receiver receives at least one of second reflected wave signal corresponding to second sound wave signal transmitted from the second transmitter and first reflected wave signal corresponding to first wave signal transmitted from the first transmitter,
the second receiver receives at least one of the first reflected wave signal and the second reflected wave signal,
the relative velocity calculator is configured to calculate a first relative velocity which is a relative velocity of the object with respect to the first transmitter or a relative velocity of the first transmitter with respect to the object using a reflected wave signal received by the first receiver, and calculate a second relative velocity which is a relative velocity of the object with respect to the second transmitter or a relative velocity of the second transmitter with respect to the object using a reflected wave signal received by the second receiver,
the time-of-flight measurer is configured to measure a first time of flight which is a time from a transmission of the first wave signal by the first transmitter to an arrival of the first reflected wave signal at the first receiver or the second receiver and a second time of flight which is a time from a transmission of the second wave signal by the second transmitter to an arrival of the second reflected wave signal at the first receiver or the second receiver, and
the position identifier is configured to identify a first position of each of the plurality of objects using a plurality of first relative velocities and a plurality of first times of flight, identify a second position each of the plurality of objects using a plurality of second relative velocities and a plurality of second times of flight, and identify a position of each of the plurality of objects using the first position of each of the plurality of objects and the second position each of the plurality of objects.

17. A measurement method comprising:
outputting a plurality of different relative velocities of a plurality of objects with respect to a moving body or a plurality of different relative velocities of the moving body with respect to the plurality of objects using multiple reflected wave signals formed by one of multiple sound wave signals being reflected by the plurality of objects and received respectively by one or more receivers provided in the moving body, the multiple sound wave signals having been transmitted respectively from one or more transmitters provided in the moving body toward the plurality of objects;
measuring a plurality of times of flight, each time of flight being a time until the one of the multiple sound wave signals is transmitted from the one or more transmitters, reflected by the plurality of objects and reach respective the one or more receivers; and
identifying respective positions of the plurality of objects based on the plurality of different relative velocities outputted in the outputting and the plurality of times of flight measured in the measuring.

18. A vehicle control apparatus comprising:
a relative velocity calculator configured to output a plurality of different relative velocities of a plurality of objects with respect to a moving body or a plurality of different relative velocities of the moving body with respect to the plurality of objects using multiple reflected wave signals formed by one of multiple sound wave signals being reflected by the plurality of objects and received respectively by one or more receivers provided in the moving body, the multiple sound wave signals having been transmitted respectively from one or more transmitters provided in the moving body toward the plurality of objects;
a time-of-flight measurer configured to measure a plurality of times of flight, each time of flight being a time until the one of the multiple sound wave signals is transmitted from the one or more transmitters, reflected by the plurality of objects and reach respective the one or more receivers;
a position identifier configured to identify respective positions of the plurality of objects based on the plurality of different relative velocities calculated by the relative velocity calculator and the plurality of times of flight measured by the time-of-flight measurer;
a parking space determiner configured to determine a parking space for parking the moving body based on the positions of the plurality of objects identified by the position identifier and the size of the moving body; and
a parking controller configured to park the moving body in the parking space determined by the parking space determiner.

19. A vehicle control apparatus according to claim 18, further comprising:
a collision determiner configured to determine whether there is a possibility of collision between the moving body and one of the plurality of objects based on the positions of the plurality of objects identified by the position identifier and the size of the moving body; and
a movement controller configured to control movement of the moving body to avoid collision with the plurality of objects when there is the possibility of collision between the moving body and one of the plurality of objects.

20. The vehicle control apparatus according to claim 19, wherein the movement controller stops the moving body when there is the possibility of collision between the moving body and one of the plurality of objects.

21. The vehicle control apparatus according to claim 19, wherein the collision determiner further determines whether there is the possibility of collision between the moving body and one of the plurality of objects based on a moving state of the moving body.

22. The vehicle control apparatus according to claim 19, wherein:
the one or more transmitters include a first transmitter and a second transmitter, positions of the first transmitter and the second transmitter being different from each other,
the one or more receivers include a first receiver corresponding to the first transmitter and a second receiver corresponding to the second transmitter, positions of the first receiver and the second receiver being different from each other,
the first receiver receives at least one of second reflected wave signal corresponding to second sound wave signal transmitted from the second transmitter and first reflected wave signal corresponding to first wave signal transmitted from the first transmitter,
the second receiver receives at least one of the first reflected wave signal and the second reflected wave signal,
the relative velocity calculator is configured to calculate a first relative velocity which is a relative velocity of the object with respect to the first transmitter or a relative velocity of the first transmitter with respect to the object using a reflected wave signal received by the first receiver, and calculate a second relative velocity which is a relative velocity of the object with respect to the second transmitter or a relative velocity of the second transmitter with respect to the object using a reflected wave signal received by the second receiver,
the time-of-flight measurer is configured to measure a first time of flight which is a time from a transmission of the first wave signal by the first transmitter to an arrival of the first reflected wave signal at the first receiver or the second receiver and a second time of flight which is a time from a transmission of the second wave signal by the second transmitter to an arrival of the second reflected wave signal at the first receiver or the second receiver, and
the position identifier is configured to identify a first position of each of the plurality of objects using a plurality of first relative velocities and a plurality of first times of flight, identify a second position each of the plurality of objects using a plurality of second relative velocities and a plurality of second times of flight, and identify a position of each of the plurality of objects using the first position of each of the plurality of objects and the second position each of the plurality of objects.

23. The measurement apparatus according to claim 13, wherein the position identifier identifies positions of surfaces of the plurality of objects using the multiple reflected wave signals received respectively by the one or more receivers, the surfaces being substantially orthogonal to a travelling direction of the one of the multiple sound wave signals.
